(19) United States
(12) Patent Application Publication
(10) Pub. No.: US 2026/0227769 A1
(43) Pub. Date: Aug. 6, 2026

(54) METHOD FOR PROCESSING DATA USED IN PRODUCING COUPLER AND RELATED DEVICES

(71) Applicant: SHENZHEN RSPOWER TECHNOLOGY CO., LTD., Shenzhen (CN)

(72) Inventors: Shuxiao WANG, Shenzhen (CN); Yati CHEN, Shenzhen (CN)

(21) Appl. No.: 19/634,224

(22) Filed: Mar. 31, 2026

Related U.S. Application Data
(63) Continuation of application No. PCT/CN2024/108699, filed on Jul. 31, 2024.

(30) Foreign Application Priority Data
Dec. 22, 2023 (CN) 202311774052.X

(51) Int. Cl. G05B 19/418

(52) U.S. Cl. CPC G05B 19/41865; G05B 19/4183

(57) ABSTRACT

A method for processing data used in producing a coupler and related devices are provided. The method includes the following. Reference product data is determined, where the reference product data includes a preset spacing between a transmission line and a microstrip line of a coupler to be produced. A target production device is searched for according to the reference product data. Actual product data of a coupler that is produced by the target production device according to the reference product data is acquired. A target production error value is determined according to the actual spacing and the preset spacing. Target material information is searched for according to the target production error value. A production instruction message including the target material information is sent to the target production device to use a material determined according to the target material information to produce a dielectric layer of the coupler.

This application is a continuation of International Application No. PCT/CN 2024/108699, filed Jul. 31, 2024, which claims priority to Chinese Patent Application No. 202311774052.X, filed Dec. 22, 2023, the entire disclosures of both of which are incorporated herein by reference.

### TECHNICAL FIELD

The present disclosure relates to the field of data processing technology, and in particular, to a method for processing data used in producing coupler and related devices.

### BACKGROUND

Before production, devices are designed according to required functions to obtain production data needed for production, so that mass production can be performed according to the production data to obtain products that possess the required functions. However, during the production, due to production errors, produced products often fail to meet the requirements. Moreover, the smaller the product being produced, the greater the functional deviation caused by minor production errors, thereby making it impossible to achieve the required functions. Taking a coupler for example, during production, a distance between a microstrip line and a transmission line of an actual produced coupler often differs from a pre-designed distance, resulting in a produced coupler with low precision and consequently low accuracy in detection results.

### SUMMARY

In a first aspect, the disclosure provides a method for processing data used in producing a coupler, which includes the following. Reference product data is determined, where the reference product data includes a preset spacing between a transmission line of a coupler to be produced and a microstrip line of the coupler to be produced, and a dielectric layer is disposed between the transmission line and the microstrip line. A target production device is searched for according to the reference product data if not finding target production information corresponding to the reference product data. Production information includes a correspondence among different production devices, different material information, and product data of different reference couplers. The material information includes information of a material used to be disposed in a dielectric layer of the reference coupler to compensate for a production error value. The production error value represents a difference between a spacing between a transmission line and a microstrip line in product data and a spacing between a transmission line and a microstrip line of a coupler produced by a production device according to the product data. Actual product data of a coupler that is produced by the target production device according to the reference product data is acquired. The actual product data includes an actual spacing between a transmission line and a microstrip line of the coupler produced by the target production device. A target production error value is determined according to the actual spacing and the preset spacing. Corresponding target material information is searched for according to the target production error value. A production instruction message is sent to the target production device. The production instruction message includes the target material information. The production instruction message is used to instruct the target production device to use a material determined according to the target material information to produce a dielectric layer applicable to the coupler produced according to the reference product data.

In a second aspect, the disclosure provides a coupler, which includes a transmission line, a microstrip line, and a dielectric layer. The microstrip line is spaced apart from the transmission line, and a detection point is disposed on the microstrip line. The dielectric layer is disposed between the transmission line and the microstrip line. Material of the dielectric layer is determined according to a target production error value. The target production error value represents a difference between a preset spacing in reference product data and an actual spacing in actual product data. The preset spacing represents a spacing set in advance between the microstrip line and the transmission line. The actual product data represents data of a coupler produced by a target production device according to the reference product data. The actual spacing represents a spacing between a transmission line of a produced coupler and a microstrip line of the produced coupler.

In a third aspect, the disclosure provides an electronic device, including one or more processors and one or more memories configured to store a program. The one or more memories and the program are configured to, by the one or more processors, control the electronic device to execute instructions of operations in any one of the methods according to the first aspect of the embodiments of the disclosure.

### BRIEF DESCRIPTION OF THE DRAWINGS

In order to describe the technical solutions in the embodiments of the disclosure or the prior art more clearly, the following briefly introduces the drawings required for describing the embodiments or the prior art. Apparently, the drawings in the following are only some embodiments of the disclosure. For a person of ordinary skill in the art, other drawings can be obtained according to these drawings without creative effort.

FIG. 1 is a schematic structural diagram of a control system provided in embodiments of the disclosure.

FIG. 2 is a schematic diagram of a server provided in embodiments of the disclosure.

FIG. 3 is a flowchart of a method for processing data used in producing a coupler provided in embodiments of the disclosure.

FIG. 4 is a schematic structural diagram of a coupler provided in embodiments of the disclosure.

FIG. 5 is a block diagram of functional units of a device for processing data used in producing a coupler provided in embodiments of the disclosure.

### DETAILED DESCRIPTION

To enable those skilled in the art to better understand the solutions of the disclosure, the following clearly and completely describes the technical solutions in the embodiments of the disclosure with reference to the drawings in the embodiments of the disclosure. Apparently, the described embodiments are only a part of the embodiments of the disclosure, but not all of the embodiments. Based on the embodiments in the disclosure, all other embodiments obtained by a person of ordinary skill in the art without creative effort shall fall within the protection scope of the disclosure.

The terms “first”, “second”, etc., in the specification and claims of the disclosure and the above-mentioned drawings are used to distinguish different objects, and not used to describe a specific order. Furthermore, the terms “comprise” and “include” and any variations thereof are intended to cover non-exclusive inclusion. For example, a process, method, system, product, or device including a series of steps or units is not necessarily limited to those expressly listed steps or units, but may optionally include other steps or units not listed, or optionally include other steps or units inherent to these processes, methods, products, or devices.

Reference to an “embodiment” herein means that a particular feature, structure, or characteristic described in connection with the embodiment may be included in at least one embodiment of the disclosure. The appearances of this phrase in various places in the specification are not necessarily all referring to the same embodiment, nor are they separate or alternative embodiments mutually exclusive of other embodiments. It is understood, both explicitly and implicitly, by those skilled in the art that the embodiments described herein may be combined with other embodiments.

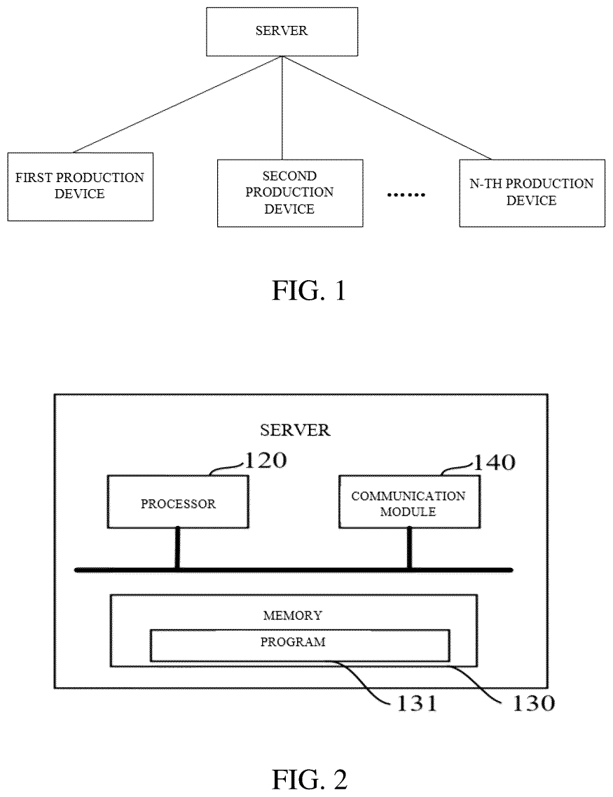

Reference is made to FIG. 1, which is a schematic structural diagram of a control system provided in embodiments of the disclosure. As illustrated in FIG. 1, the control system includes a server and at least one production device connected to the server. The at least one production device may include a first production device, a second production device, . . . an N-th production device, to accommodate the production of couplers having different product data. The method in the disclosure may be applied to a server to control the production devices in the system for production. The server in the disclosure may also be replaced by other control devices, or the server and the production device may be integrated, which is not specifically limited here.

Reference is made to FIG. 2, which is a schematic diagram of a server provided in embodiments of the disclosure. As illustrated in FIG. 2, the server includes a processor 120, a memory 130, a communication module 140, and a program 131. The quantity of processors 120 may be set according to actual requirements. The processor 120 communicates with the memory 130 and the communication module 140 via an internal communication bus.

The program 131 is stored in the memory 130 and is configured to be executed by the processor 120. The program 131 includes instructions for executing any operation in the following method embodiments. It may be understood that, the quantity of programs 131 may be set according to actual requirements, which is not specifically limited here.

The processor 120 may be, for example, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. It may implement or execute various exemplary logical blocks, units, and circuits described in combination with the disclosed contents of the disclosure. The processor 120 may also be a combination that implements computing functions, for example, including one or more microprocessor combinations, a combination of a DSP and a microprocessor, etc. The communication unit may be the communication module 140, a transceiver, a transceiver circuit, etc. The storage unit may be the memory 130.

The memory 130 may be a volatile memory or a non-volatile memory, or may include both volatile and non-volatile memories. The non-volatile memory may be a read-only memory (ROM), a programmable ROM (PROM), an erasable PROM (EPROM), an electrically EPROM (EEPROM), or a flash memory. The volatile memory may be a random access memory (RAM), which serves as an external cache. By way of exemplary but not limiting illustration, many forms of random access memory (RAM) are available, such as static RAM (SRAM), dynamic RAM (DRAM), synchronous DRAM (SDRAM), double data rate SDRAM (DDR SDRAM), enhanced SDRAM (ESDRAM), synchlink DRAM (SLDRAM), and direct rambus RAM (DR RAM).

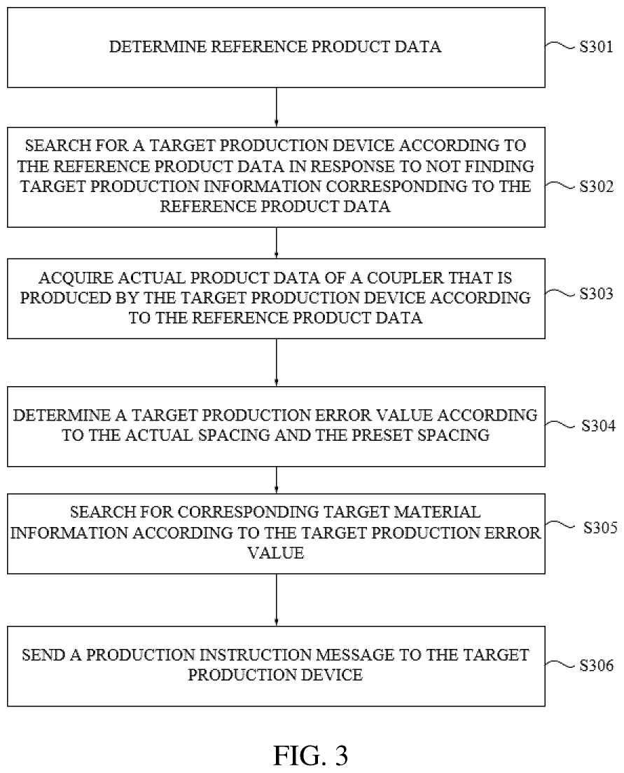

Reference is made to FIG. 3, which is a flowchart of a method for processing data used in producing a coupler provided in embodiments of the disclosure. The method involved in the embodiments of the disclosure will be described in the following in detail with reference to the accompanying drawings. As illustrated in FIG. 3, a method for processing data used in producing a coupler includes the following.

At S301, reference product data is determined.

The reference product data includes a preset spacing between a transmission line of a coupler to be produced and a microstrip line of the coupler to be produced, and a dielectric layer is disposed between the transmission line and the microstrip line. Specifically, the reference product data is pre-set data of various components of the coupler to be produced, and the reference product data is used to instruct a production device for production. The coupler to be produced includes a transmission line, a microstrip line, and a dielectric layer. The dielectric layer is disposed between the transmission line and the microstrip line, and the reference product data includes the preset spacing between the transmission line and the microstrip line.

At S302, a target production device is searched for according to the reference product data if not finding target production information corresponding to the reference product data.

Production information includes a correspondence among different production devices, different material information, and product data of different reference couplers. The material information includes information of a material used to be disposed in a dielectric layer of the reference coupler to compensate for a production error value. The production error value represents a difference between a spacing between a transmission line and a microstrip line in product data and a spacing between a transmission line and a microstrip line of a coupler produced by a production device according to the product data. The production device is a device used for producing couplers.

The target production information corresponding to the reference product data is searched for. If the corresponding target production information is found, the production device and material information in the corresponding target production information are determined, and the material information is sent to the target production device to instruct the target production device to add the material determined according to the material information into the dielectric layer during production, eliminating the need of secondary search for a production device capable of producing the coupler to be produced and for material information to compensate for the production error. In this way, the production efficiency is improved, the production precision is also improved, and the accuracy of the detection results of the coupler is enhanced. If the target production information corresponding to the reference product data is not found, a target production device capable of producing the coupler to be produced is searched for according to the reference product data, to provide data support for subsequent operations.

At S303, actual product data of a coupler that is produced by the target production device according to the reference product data is acquired.

The actual product data includes an actual spacing between a transmission line and a microstrip line of the coupler produced by the target production device. Specifically, after determining the target production device, the target production device is instructed to produce a coupler according to the reference product data, thereby acquiring the actual product data. This provides data support for subsequent operations.

At S304, a target production error value according to the actual spacing and the preset spacing is determined.

The actual spacing in the actual product data and the preset spacing in the reference product data are obtained, and the target production error value is determined according to the actual spacing and the preset spacing.

At S305, corresponding target material information is searched for according to the target production error value.

Corresponding target material information is searched for according to the target production error value. The target material information includes information of a material used to be disposed in the dielectric layer of the coupler to compensate for the production error value.

At S306, a production instruction message is sent to the target production device.

The production instruction message includes the target material information. The production instruction message is used to instruct the target production device to use a material determined according to the target material information to produce a dielectric layer applicable to the coupler produced according to the reference product data. After determining the target material information, the production instruction message is generated according to the target material information, and the production instruction message is sent to the target production device to instruct the target production device to use the material determined according to the target material information to produce the dielectric layer applicable to the coupler produced according to the reference product data. That is, during processing the coupler by the target production device according to the reference product data, the dielectric layer produced with the material determined according to the target material information is applied to the coupler, thereby compensating for the production error of the target production device.

Thus, in this embodiment, the target production error value can be predetermined according to the preset spacing in the reference product data and the actual spacing in the actual product data obtained from actual production, and the corresponding target material information can be determined according to the target production error value, so as to use the target material information to compensate for the production error. In this way, the production precision is improved, and the accuracy of the detection results of the coupler is enhanced.

In a possible embodiment, after sending the production instruction message to the target production device, the information of the target production device, the reference product data, and the target material information are stored in a preset database, so that when a coupler corresponding to the reference product data is to be produced again, the target production device and the target material information can be quickly determined, improving production efficiency.

In a possible embodiment, acquiring the actual product data of the coupler produced by the target production device according to the reference product data includes: acquiring multiple first product data of multiple couplers that are produced by the target production device according to the reference product data in a first preset environment; acquiring first mean data by calculating a mean value of data of a same type among the multiple first product data; acquiring multiple second product data of multiple couplers that are produced by the target production device according to the reference product data in a second preset environment; acquiring second mean data by calculating a mean value of data of a same type among the multiple second product data; and acquiring the actual product data by calculating an average value of data of a same type in both the first mean data and the second mean data.

In a specific embodiment, couplers that are produced by the target production device in different environments may differ. Multiple first product data of multiple couplers that are produced by the target production device according to the reference product data in a first preset environment are acquired. Specifically, the preset environment may include environmental data such as temperature, humidity, light, aerosol concentration, and air pressure. A mean value of data of a same type among the obtained multiple first product data is calculated to obtain first mean data. For example, each first product data includes a spacing. The sum of the spacings in the multiple first product data is calculated, and a mean spacing is obtained according to the sum and the quantity (number) of spacings in the multiple first product data. The first mean data includes the mean spacing. Similarly, multiple second product data of multiple couplers that are produced by the target production device according to the reference product data in a second preset environment are acquired. A mean value of data of a same type among the multiple second product data is calculated to obtain second mean data. An average value of data of a same type in both the first mean data and the second mean data is calculated to obtain the actual product data.

As can be seen, in this embodiment, different mean data of couplers that are produced by the target production device in different preset environments are obtained, and the actual product data is determined according to the different mean data. In this way, the accuracy of the determined actual product data is improved, and thus the precision of the produced coupler is improved.

In a possible embodiment, searching for corresponding target material information according to the target production error value includes: determining a target dielectric constant according to the target production error value; searching for a reference dielectric constant from a preset database, where a difference between the reference dielectric constant and the target dielectric constant falls within a preset numerical range, and the preset database includes a correspondence between different material information and different dielectric constants; if the quantity of the reference dielectric constant exceeds a preset quantity, acquiring a price list formed by material prices from material information corresponding to each of the reference dielectric constants; and searching for a lowest material price in the price list; and taking the material information corresponding to the lowest material price as the target material information.

In a specific embodiment, different materials correspond to different dielectric constants. When there is a production error value in the spacing between the microstrip line and the transmission line, the material of the dielectric layer is changed, so that the dielectric constant is changed, thereby compensating for the production error value between the microstrip line and the transmission line. After determining the target production error value, a target dielectric constant is determined according to the target production error value. A reference dielectric constant is searched for from a preset database, where a difference between the reference dielectric constant and the target dielectric constant falls within a preset numerical range. The material information corresponding to the reference dielectric constant includes information of the required material. If the quantity of found reference dielectric constants exceeds a preset quantity, meaning there are multiple selectable materials, the material prices from the material information corresponding to each reference dielectric constant are obtained, and a price list formed by the material prices is obtained. The lowest material price in the price list is searched for, and the material information corresponding to the lowest material price is taken as the target material information.

As can be seen, in this embodiment, a material for compensating for the production error is determined according to the target production error value, and in the case where multiple material information is available, a lower-priced material is preferentially selected. In this way, production precision is ensured, while facilitating material acquisition and reducing production costs.

In a possible embodiment, searching for corresponding target material information according to the target production error value includes: determining a target dielectric constant according to the target production error value; searching for a reference dielectric constant from a preset database, where a difference between the reference dielectric constant and the target dielectric constant falls within a preset numerical range, and the preset database includes a correspondence between different material information and different dielectric constants; if the quantity of the reference dielectric constant exceeds a preset quantity, acquiring a material information set that is formed by material information corresponding to each of the reference dielectric constants; searching for material information containing the fewest material types in the material information set; and determining the material information containing the fewest material types as the target material information.

In a specific embodiment, different materials correspond to different dielectric constants. The material information may include one material or multiple materials, i.e., the material determined according to the material information may be a single material or a mixture of materials. After determining the target production error value, a target dielectric constant is determined according to the target production error value. A reference dielectric constant is searched for from a preset database, where a difference between the reference dielectric constant and the target dielectric constant falls within a preset numerical range, and the material information corresponding to the reference dielectric constant is obtained. If the quantity of found reference dielectric constants exceeds a preset quantity, meaning materials corresponding to multiple material information can be used to compensate for the production error, a material information set formed by the material information corresponding to each reference dielectric constant is obtained. Material information containing the fewest material types in the material information set is searched for; and the material information containing the fewest material types is determined as the target material information.

As can be seen, in this embodiment, if there are multiple selectable material information, the material information containing the fewest material types is preferentially selected, so that the production precision and the production efficiency are ensured.

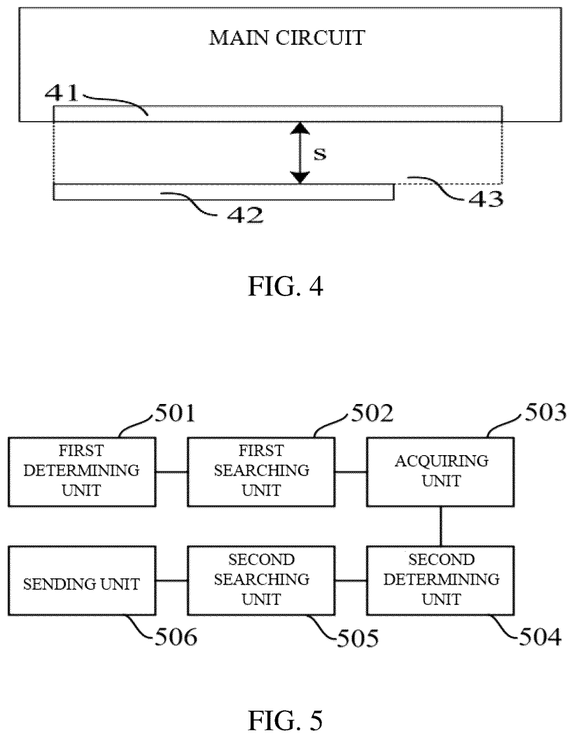

Reference is made to FIG. 4, which is a schematic structural diagram of a coupler provided in embodiments of the disclosure. As illustrated in FIG. 4, a coupler includes a transmission line 41, a microstrip line 42, and a dielectric layer 43. The microstrip line 42 is spaced apart from the transmission line 41, and a detection point is disposed on the microstrip line 42. The dielectric layer 43 is disposed between the transmission line 41 and the microstrip line 42. The material of the dielectric layer 43 is determined according to a target production error value. The target production error value represents a difference between a preset spacing in reference product data and an actual spacing in actual product data. The preset spacing represents a spacing set in advance between the microstrip line 42 and the transmission line 41. The actual product data represents data of a coupler produced by a target production device according to the reference product data, and the actual spacing represents a spacing between the transmission line 41 and the microstrip line 42 of the produced coupler.

Specifically, the coupler includes the transmission line 41, the microstrip line 42, and the dielectric layer 43 that are disposed on a main circuit. The transmission line 41 and the microstrip line 42 are spaced apart from each other, and the dielectric layer 43 is disposed between the transmission line 41 and the microstrip line 42. Specifically, when the transmission line 41 is energized, the microstrip line 42 is subject to the dual action of a magnetic field and an electric field influenced by the current. When the microstrip line 42 and the transmission line 41 are spaced at a certain distance, the electric field strength and the magnetic field strength at a first end of the microstrip line 42 are equal in magnitude and opposite in direction, and the electric field strength and the magnetic field strength at a second end of the microstrip line 42 are equal in magnitude and same in direction. Since the magnetic field strength exhibits opposite polarities at the two ends of the microstrip line 42, there is a point in the middle of the microstrip line 42 where the magnetic field strength is zero. The voltage detected at this point is zero. In this case, the distance between the microstrip line 42 and the transmission line 41 is the preset spacing. The voltage detected at the end points of the microstrip line 42 is the voltage of the transmission line 41. The radio frequency power can be calculated according to the voltage of the transmission line 41. However, due to production errors during production by the production device, there is a difference between the preset spacing and actual spacing s between the produced microstrip line 42 and transmission line 41, so that the point of zero magnetic field strength shifts, thereby causing an error in the voltage detected at the originally set detection point, and thus affecting the accuracy of the finally calculated radio frequency power. In this solution, the material of the dielectric layer 43 is determined according to a target production error value, and the target production error value represents the difference between the preset spacing and actual spacing s between the transmission line 41 and the microstrip line 42 in the actual product data. That is, the target production device produces the coupler according to the reference product data, the actual product data of the produced coupler is obtained, the target production error value is determined according to the actual spacing s in the actual product data and the preset spacing in the reference product data, and the material disposed in the dielectric layer 43 is determined according to the target production error value, thereby changing the dielectric constant of the dielectric layer 43. With the material disposed in the dielectric layer 43, the target production error value generated in the production process is compensated, so that the voltage at the detection point is zero when the transmission line 41 and the microstrip line 42 are spaced at the actual spacing s.

As can be seen, in this embodiment, the material disposed in the dielectric layer 43 in the coupler is determined according to the target production error value, so that the voltage at the detection point is still zero even when the spacing between the microstrip line 42 and the transmission line 41 of the coupler does not reach the preset spacing but equals the actual spacing s. In this way, the accuracy of the voltage detected by the coupler, thereby improving the accuracy of the radio frequency power obtained through detection.

In a possible embodiment, the microstrip line extends straight in a length direction of the transmission line and is parallel to the transmission line. The detection point is disposed at a midpoint of the microstrip line.

In a specific embodiment, the microstrip line of the coupler extends straight in the length direction of the transmission line, and the microstrip line and the transmission line are parallel to each other. The detection point is disposed at the midpoint of the microstrip line, so that the magnetic field strength and electric field strength in the space where the microstrip line is located are uniform, thereby improving the accuracy of the detection result. It may be understood that, the transmission line may be a microstrip line or a wire, which is not specifically limited here.

A radio frequency detection apparatus is provided in embodiments of the disclosure. The radio frequency detection apparatus is configured to detect radio frequency power, and the radio frequency detection apparatus includes the above-mentioned coupler, thereby improving detection accuracy.

A device for processing data used in producing a coupler is provided in embodiments of the disclosure. Specifically, the device for processing data used in producing a coupler provided in embodiments of the disclosure may include modules corresponding to respective operations.

In the embodiments of the disclosure, the device for processing data used in producing a coupler may be divided into functional modules according to the above method embodiments. For example, each functional module may be divided corresponding to each function, or two or more functions may be integrated into one processing module. The above-mentioned integrated modules may be implemented in the form of hardware or in the form of software functional modules. The division of modules in the embodiment of the disclosure is schematic and is only a logical function division. There may be other division manners in actual implementation.

In the case of dividing each functional module corresponding to each function, reference is made to FIG. 5, which is a block diagram of functional units of a device for processing data used in producing a coupler provided in embodiments of the disclosure. The device includes a first determining unit 501, a first searching unit 502, an acquiring unit 503, a second determining unit 504, a second searching unit 505, a sending unit 506.

The first determining unit 501 is configured to determine reference product data. The reference product data includes a preset spacing between a transmission line of a coupler to be produced and a microstrip line of the coupler to be produced, and a dielectric layer is disposed between the transmission line and the microstrip line.

The first searching unit 502 is configured to search for a target production device according to the reference product data if not finding target production information corresponding to the reference product data. Production information includes a correspondence among different production devices, different material information, and product data of different reference couplers. The material information includes information of a material used to be disposed in a dielectric layer of the reference coupler to compensate for a production error value, and the production error value represents a difference between a spacing between a transmission line and a microstrip line in product data and a spacing between a transmission line and a microstrip line of a coupler produced by a production device according to the product data.

The acquiring unit 503 is configured to acquire actual product data of a coupler that is produced by the target production device according to the reference product data. The actual product data includes an actual spacing between a transmission line and a microstrip line of the coupler produced by the target production device.

The second determining unit 504 is configured to determine a target production error value according to the actual spacing and the preset spacing.

The second searching unit 505 is configured to search for corresponding target material information according to the target production error value.

The sending unit 506 is configured to send a production instruction message to the target production device. The production instruction message includes the target material information. The production instruction message is used to instruct the target production device to use a material determined according to the target material information to produce a dielectric layer applicable to the coupler produced according to the reference product data.

In a possible embodiment, the acquiring unit 503 is further configured to: acquire multiple first product data of multiple couplers that are produced by the target production device according to the reference product data in a first preset environment; calculate a mean value of data of a same type among the multiple first product data to obtain first mean data; acquire multiple second product data of multiple couplers that are produced by the target production device according to the reference product data in a second preset environment; calculate a mean value of data of a same type among the multiple second product data to obtain second mean data; and calculate an average value of data of a same type in both the first mean data and the second mean data to obtain the actual product data.

In a possible embodiment, the second searching unit 505 is further configured to:
determine a target dielectric constant according to the target production error value; search for a reference dielectric constant from a preset database, where a difference between the reference dielectric constant and the target dielectric constant falls within a preset numerical range, and the preset database includes a correspondence between different material information and different dielectric constants; acquire a price list formed by material prices from material information corresponding to each of the reference dielectric constants if the quantity of the reference dielectric constant exceeds a preset quantity; search for a lowest material price in the price list;
and take the material information corresponding to the lowest material price as the target material information.

In a possible embodiment, the second searching unit 505 is further configured to:
determine a target dielectric constant according to the target production error value; search for a reference dielectric constant from a preset database, where a difference between the reference dielectric constant and the target dielectric constant falls within a preset numerical range, and the preset database includes a correspondence between different material information and different dielectric constants; acquire a material information set that is formed by material information corresponding to each of the reference dielectric constants if the quantity of the reference dielectric constant exceeds a preset quantity; search for material information containing the fewest material types in the material information set; and determine the material information containing the fewest material types as the target material information.

The beneficial effects brought by the technical solutions provided by some embodiments of the disclosure include at least the following.

In the embodiments of the disclosure, firstly, reference product data is determined, where the reference product data includes a preset spacing between a transmission line of a coupler to be produced and a microstrip line of the coupler to be produced, and a dielectric layer is disposed between the transmission line and the microstrip line. A target production device is searched for according to the reference product data if not finding target production information corresponding to the reference product data. Specifically, production information includes a correspondence among different production devices, different material information, and product data of different reference couplers. The material information includes information of a material used to be disposed in a dielectric layer of the reference coupler to compensate for a production error value. The production error value represents a difference between a spacing between a transmission line and a microstrip line in product data and a spacing between a transmission line and a microstrip line of a coupler produced by a production device according to the product data. Actual product data of a coupler that is produced by the target production device according to the reference product data is acquired. The actual product data includes an actual spacing. A target production error value is determined according to the actual spacing and the preset spacing. Corresponding target material information is searched for according to the target production error value. A production instruction message is sent to the target production device. The production instruction message includes the target material information, so as to instruct the target production device to use a material determined according to the target material information to produce a dielectric layer applicable to the coupler produced according to the reference product data. In the disclosure, by detecting whether the target production information corresponding to the reference product data exists, i.e., determining whether the coupler to be produced has been produced before, if the coupler to be produced has not been produced, a target production device capable of producing the coupler to be produced is searched for. In this way, manual matching is avoided, and the production efficiency is improved. After determining the target production device, the actual product data of the coupler produced by the target production device according to the reference product data is acquired. A target production error is determined according to the actual spacing in the actual product data and the preset spacing, so that the target material information is determined, and the target production device is instructed to use the material determined according to the target material information to produce a coupler. Thus, a coupler with higher precision is obtained, thereby improving the accuracy of the detection results of the coupler.

The above embodiments may be implemented in whole or in part by software, hardware, firmware, or any other combination. When implemented using software, the above embodiments may be implemented in whole or in part in the form of a computer program product. The computer program product includes one or more computer instructions or computer programs. When the computer instructions or computer programs are loaded or executed on a computer, the processes or functions according to the embodiments of the disclosure are generated in whole or in part. The computer may be a general-purpose computer, a special-purpose computer, a computer network, or other programmable devices. The computer instructions may be stored in a computer-readable storage medium or transmitted from one computer-readable storage medium to another computer-readable storage medium, for example, the computer instructions may be transmitted from one website site, computer, server, or data center to another website site, computer, server, or data center by wire or wirelessly. The computer-readable storage medium may be any available medium that a computer can access or a data storage device such as a server, a data center, etc., that includes one or more available media sets. The available medium may be a magnetic medium (e.g., a floppy disk, a hard disk, a magnetic tape), an optical medium (e.g., a DVD), or a semiconductor medium. The semiconductor medium may be a solid-state drive.

A computer storage medium is further provided in embodiments of the disclosure. The computer storage medium stores a computer program for electronic data exchange. The computer program causes a computer to perform part or all of the operations of any one of the methods described in the above method embodiments, and the above-mentioned computer includes an electronic device.

A computer program product is further provided in embodiments of the disclosure. The computer program product includes a computer program, and the computer program is operable to cause a computer to perform part or all of the operations of any one of the methods described in the above method embodiments.

The computer program product may be a software installation package, and the above-mentioned computer includes an electronic device.

It may be understood that, in various embodiments of the disclosure, the size of the sequence numbers of the above processes does not imply an order of execution, and the execution order of each process may be determined by its function and inherent logic, and may not constitute any limitation on the implementation process of the embodiments of the disclosure.

In the several embodiments provided in the disclosure, it may be understood that the disclosed methods, devices, and systems may be implemented in other ways. For example, the apparatus embodiments described above are only illustrative. For example, the division of the units is only a logical function division, and there may be other division manners in actual implementation. For example, multiple units or components may be combined or integrated into another system, or some features may be ignored, or not executed. In addition, the mutual coupling or direct coupling or communication connection shown or discussed may be through some interfaces, indirect coupling or communication connection of devices or units, and may be in electrical, mechanical, or other forms.

The units described as separate components may or may not be physically separated, and the components displayed as units may or may not be physical units, i.e., may be located in one place or may be distributed over multiple network units. Some or all of the units may be selected according to actual needs to achieve the purpose of the solution of the embodiment.

In addition, each functional unit in each embodiment of the present disclosure may be integrated into one processing unit, or each unit may be physically included separately, or two or more units may be integrated into one unit. The above-mentioned integrated units may be implemented in the form of hardware or in the form of hardware plus software functional units.

The above-mentioned integrated units implemented in the form of software functional units may be stored in a computer-readable storage medium. The above-mentioned software functional units are stored in a storage medium and include several instructions for causing a computer device (which may be a personal computer, a server, or a network device, etc.) to perform part of the steps of the methods described in various embodiments of the present invention. The aforementioned storage medium includes various media that can store program codes, such as a U disk, a mobile hard disk, a read-only memory (ROM), a random access memory (RAM), a magnetic disk, or an optical disk.

Although the present disclosure is disclosed as above, the present disclosure is not limited thereto. Any person skilled in the art can easily think of changes or substitutions without departing from the spirit and scope of the present disclosure, and can make various changes and modifications, including combinations of different functions and implementation steps mentioned above, including implementation modes of software and hardware, all within the protection scope of the present disclosure.

What is claimed is:

1. A method for processing data used in producing a coupler, comprising:
determining reference product data, wherein the reference product data comprises a preset spacing between a transmission line of a coupler to be produced and a microstrip line of the coupler to be produced, and a dielectric layer is disposed between the transmission line and the microstrip line;
searching for a target production device according to the reference product data in response to not finding target production information corresponding to the reference product data, wherein production information comprises a correspondence among different production devices, different material information, and product data of different reference couplers, wherein the material information comprises information of a material used to be disposed in a dielectric layer of the reference coupler to compensate for a production error value, and the production error value represents a difference between a spacing between a transmission line and a microstrip line in product data and a spacing between a transmission line and a microstrip line of a coupler produced by a production device according to the product data;
acquiring actual product data of a coupler that is produced by the target production device according to the reference product data, wherein the actual product data comprises an actual spacing between a transmission line and a microstrip line of the coupler produced by the target production device;
determining a target production error value according to the actual spacing and the preset spacing;
determining a target dielectric constant corresponding to the target production error value;
searching for a reference dielectric constant from a preset database, wherein a difference between the reference dielectric constant and the target dielectric constant falls within a preset numerical range, and wherein the preset database comprises a correspondence between different material information and different dielectric constants;
acquiring a material information set that is formed by material information corresponding to the reference dielectric constant;
taking material information having a lowest material price in the material information set as target material information; and
sending a production instruction message to the target production device, wherein the production instruction message comprises the target material information, the production instruction message is used to instruct the target production device to use a material determined according to the target material information to produce a dielectric layer applicable to the coupler produced according to the reference product data.

2. The method according to claim 1, wherein acquiring the actual product data of the coupler produced by the target production device according to the reference product data comprises:
acquiring a plurality of first product data of a plurality of couplers that are produced by the target production device according to the reference product data in a first preset environment;
acquiring first mean data by calculating a mean value of data of a same type among the plurality of first product data;
acquiring a plurality of second product data of a plurality of couplers that are produced by the target production device according to the reference product data in a second preset environment;
acquiring a second mean data by calculating a mean value of data of a same type among the plurality of second product data; and
acquiring the actual product data by calculating an average value of data of a same type in both the first mean data and the second mean data.

3. A coupler, comprising:
a transmission line;
a microstrip line, wherein the microstrip line is spaced apart from the transmission line, and a detection point is disposed on the microstrip line; and
a dielectric layer, wherein the dielectric layer is disposed between the transmission line and the microstrip line, wherein material information of a material of the dielectric layer is material information having a lowest material price in a material information set, the material information set is formed by material information corresponding to a reference dielectric constant found from a preset database, and a difference between the reference dielectric constant and a target dielectric constant falls within a preset numerical range; the target dielectric constant is a dielectric constant corresponding to a target production error value, the target production error value represents a difference between a preset spacing in reference product data and an actual spacing in actual product data, the preset spacing represents a spacing set in advance between the microstrip line and the transmission line, the actual product data represents data of a coupler produced by a target production device according to the reference product data, the actual spacing represents a spacing between a transmission line of a produced coupler and a microstrip line of the produced coupler, and the preset database comprises a correspondence between different material information and different dielectric constants.

4. The coupler according to claim 3, wherein the microstrip line extends straight in a length direction of the transmission line and is parallel to the transmission line.

5. The coupler according to claim 4, wherein the detection point is disposed at a midpoint of the microstrip line.

6. An electronic device, comprising:
a processor; and
a memory storing a program, which, when executed by the processor, causes the processor to:
determine reference product data, wherein the reference product data comprises a preset spacing between a transmission line of a coupler to be produced and a microstrip line of the coupler to be produced, and a dielectric layer is disposed between the transmission line and the microstrip line;
search for a target production device according to the reference product data in response to not finding target production information corresponding to the reference product data, wherein production information comprises a correspondence among different production devices, different material information, and product data of different reference couplers, wherein the material information comprises information of a material used to be disposed in a dielectric layer of the reference coupler to compensate for a production error value, and the production error value represents a difference between a spacing between a transmission line and a microstrip line in product data and a spacing between a transmission line and a microstrip line of a coupler produced by a production device according to the product data;
acquire actual product data of a coupler that is produced by the target production device according to the reference product data, wherein the actual product data comprises an actual spacing between a transmission line and a microstrip line of the coupler produced by the target production device;
determine a target production error value according to the actual spacing and the preset spacing;
determine a target dielectric constant corresponding to the target production error value;
search for a reference dielectric constant from a preset database, wherein a difference between the reference dielectric constant and the target dielectric constant falls within a preset numerical range, and wherein the preset database comprises a correspondence between different material information and different dielectric constants;
acquire a material information set that is formed by material information corresponding to the reference dielectric constant;
take material information having a lowest material price in the material information set as target material information; and
send a production instruction message to the target production device, wherein the production instruction message comprises the target material information, the production instruction message is used to instruct the target production device to use a material determined according to the target material information to produce a dielectric layer applicable to the coupler produced according to the reference product data.

7. The electronic device according to claim 6, wherein the program executed by the processor to cause the processor to acquire the actual product data of the coupler produced by the target production device according to the reference product data is to cause the processor to:
acquire a plurality of first product data of a plurality of couplers that are produced by the target production device according to the reference product data in a first preset environment;
acquire first mean data by calculating a mean value of data of a same type among the plurality of first product data;
acquire a plurality of second product data of a plurality of couplers that are produced by the target production device according to the reference product data in a second preset environment;
acquire a second mean data by calculating a mean value of data of a same type among the plurality of second product data; and
acquire the actual product data by calculating an average value of data of a same type in both the first mean data and the second mean data.
